(19) United States
(12) Patent Application Publication
(10) Pub. No.: US 2010/0332409 A1
(43) Pub. Date: Dec. 30, 2010

(54) Method for Detecting and Predicting Performance Trends in Stock Markets

(76) Inventor: Leon van der Linde, Moraira (ES)

Correspondence Address: WOOD AND EISENBERG, PLLC, 3975 University Drive, SUITE 330, Fairfax, VA, 22030, US

(21) Appl. No.: 12/435,345

(22) Filed: May 4, 2009

Related U.S. Application Data
(60) Provisional application No. 61/050,204, filed on May 3, 2008.
(60) Provisional application No. 61/175,007, filed on May 2, 2009.

(30) Foreign Application Priority Data
May 4, 2009 (US) PCT/US09/42758

(51) Int. Cl. G06Q 40/00

(52) U.S. Cl. 705/36 R

(57) ABSTRACT

A systematic method for detecting trends in Stock Markets' performances based on outcomes generated by a first process, comprising: a) determining a set of possible outcomes associated with a first process; (b) coding the possible outcomes to provide a plurality of separate groups, wherein each possible outcome is systematically allocated to one of the groups; (c) allocating an identifier to each of the groups; (d) monitoring in real time the first process such that actual outcomes generated by the first process are mapped to an identifier in accordance with coding step (b); (e) providing a matrix comprised of a plurality of cells arranged in rows; (f) using an exeleon allocation procedure to allocate each identifier generated in step (d) to said matrix, (for multiple-data-input) and (g) repeating step (f) until a trend of duplicating identifiers becomes self evident.

### CROSS-REFERENCE TO RELATED APPLICATIONS

This application claims the benefit of priority from U.S. Provisional Patent Application Ser. Nos. 61/050,204 (filed May, 3, 2008) and 61/175,007 (filed May 2, 2009). The entire content of Provisional Patent Application Ser. Nos. 61/050,204 and 61/175,007 are incorporated herein by reference.

### FIELD OF THE INVENTION

This invention relates to detecting and/or predicting possible trends as an aid in stock dealing.

### BACKGROUND OF THE INVENTION

Human minds typically have difficulty in quickly processing and making sense of large quantities of numeric and nonnumeric data, particularly in real time. The task of detecting trends in real time to enable rapid rational decisions is often very difficult.

While there are numerous prior software techniques for handling large volumes of data, such techniques often do not prove useful or meaningful in displaying information in an easy to understand manner to help discern trends to provide a basis for making rational decision to predict likely future outcomes. This is especially true for data relating to random events. For this type of data present mathematical tools have limited functionality in displaying and predicting possible outcomes with reproducible accuracy.

For many years economists, statisticians, and teachers of finance have been interested in developing and testing models of stock price behaviour. One important model that has evolved from this research is the theory of random walks. Random walks contrast with two approaches to predicting stock prices that are commonly espoused by market professionals. These are (1) “chartist” or “technical” theories and (2) the theory of fundamental or intrinsic value analysis.

The basic assumption of all the chartist or technical theories is that history tends to repeat itself, that is, past patterns of price behaviour in individual securities will tend to recur in the future. Thus the way to predict stock prices (and, of course, increase one's potential gains) is to develop a familiarity with past patterns of price behaviour in order to recognize situations of likely recurrence. Essentially, then, chartist techniques attempt to use knowledge of the past behaviour of a price series to predict the probable future behaviour of the series. A statistician might characterize such techniques as assuming that successive price changes in individual securities are dependent. That is, the various chartist theories assume that the sequence of price changes prior to any given day is important in predicting the price change for that day.

Most simply the theory of random walks implies that a series of stock price changes has no memory. The past history of the series cannot be used to predict the future in any meaningful way. The future path of the price level of a security is no more predictable than the path of a series of cumulated random numbers.

In sum the theory of random walks in stock market prices presents important challenges to both the chartist and the proponent of fundamental analysis. For the chartist, the challenge is straightforward. If the random walk model is a valid description of reality, the work of the chartist, like that of the astrologer, is of no real value in stock market analysis. The empirical evidence to date provides strong support for the random-walk model.

The challenge of the theory of random walks to the proponent of fundamental analysis, however, is more involved. If the random walk theory is valid and if security exchanges are “efficient” markets, then stock prices at any point in time will represent good estimates of intrinsic or fundamental values. Thus, additional fundamental analysis is of value only when the analyst has new information which was not fully considered in forming current market prices, or has new insights concerning the effects of generally available information which are not already implicit in current prices. If the analyst has neither better insights nor new information, he may as well forget about fundamental analysis and choose securities by some random selection procedure.”

Thus, a “random-walk theory” analysis methodology is desired to display and separate the sequence of price changes of shares, (high frequency performances versus low frequency performances) and in so doing, allow predicative abilities to identify high and low stock performers and also therefore stock market index movements with a higher degree of accuracy possible than other known methodology.

The Exeleon algorithm or allocation methodology of the present invention lends itself perfectly to the challenge as it is able to display, separate and to concentrate random events. In essence, the Exeleon algorithm enables users to identify and separate the higher share performers from the lower share performers.

### SUMMARY

A systematic method for detecting trends in Stock Markets' performances based on outcomes generated by a first process, comprising: a) determining a set of possible outcomes associated with a first process; (b) coding the possible outcomes to provide a plurality of separate groups, wherein each possible outcome is systematically allocated to one of the groups; (c) allocating an identifier to each of the groups; (d) monitoring in real time the first process such that actual outcomes generated by the first process are mapped to an identifier in accordance with coding step (b); (e) providing a matrix comprised of a plurality of cells arranged in rows; (f) using an Exeleon allocation procedure to allocate each identifier generated in step (d) to said matrix, (for multiple-data-input) and (g) repeating step (f) until a trend of duplicating identifiers becomes self evident.

### BRIEF DESCRIPTION OF THE DRAWINGS

FIG. 1 shows a matrix representation formulated according to the present invention in which data is inputted from point T° and flows towards point attractors (ΔTm)x and (ΔTm)y.

FIG. 2 shows an example matrix area, according to the present invention.

FIG. 3 shows an example of a matrix fill-up procedure, according to the present invention.

FIG. 4 shows an example display of matrix-separation and concentration of random events, according to the present invention.

FIG. 5 shows an example of a matrix-separation and concentration of random events within different overlapping and integrated agrupations (groupings), according to the present invention.

FIG. 6 shows an example of a matrix “mirror” concentrating the high frequency negative random appearances from the top left corner towards the bottom right corner of the matrix, according to the present invention.

FIG. 7 shows an example of a matrix operating simultaneously Exeleon “mirror”-matrix to display random appearances from the middle of the block matrix to its triangular outer points in Multiple Data Input analysis, according to the present invention.

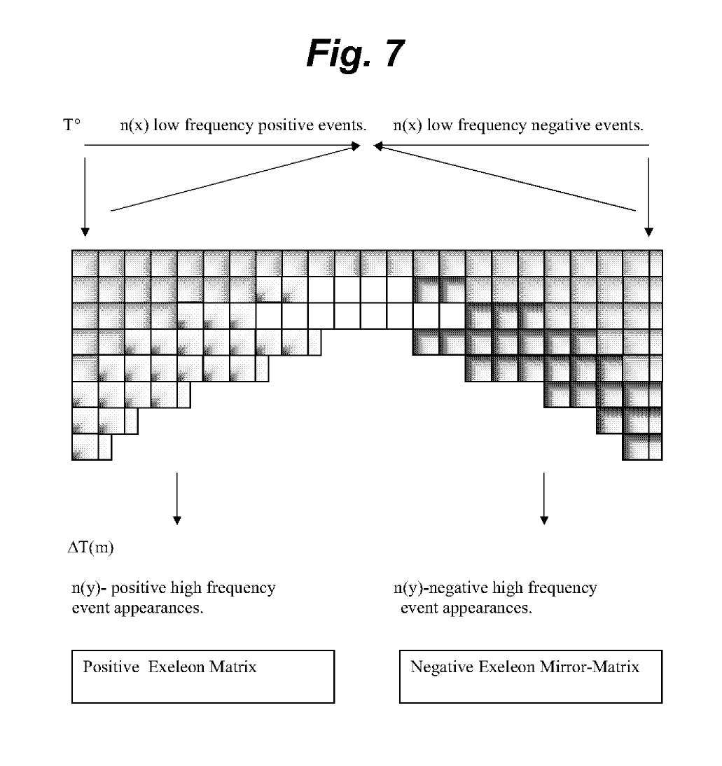

FIG. 8 shows an example of a matrix distribution pattern of share performances, according to the present invention.

FIG. 9 shows an example of a matrix distribution of share performances displaying the separation between high frequency appearances of high positive outcomes and high negative outcomes, versus low frequency appearances of low positive outcomes and low negative outcomes, according to the present invention.

FIG. 10 shows an example of a matrix distribution of share performances displaying the separation between (A) high positive outcomes and (B) high negative outcomes and (AB) low positive/low negative outcomes with multiple data input, according to the present invention.

FIG. 11 shows an example of a computing system capable of executing the embodiments of the present invention, according to the present invention.

FIG. 12 shows the computer system of FIG. 11 operably connected to one or more remote stock markets.

FIG. 13 shows a list of abbreviations.

FIG. 14 shows a way of calculating the area of the matrix of FIG. 2.

FIG. 15 shows a Table that includes information on the Exeleon Algorithm according to the present invention.

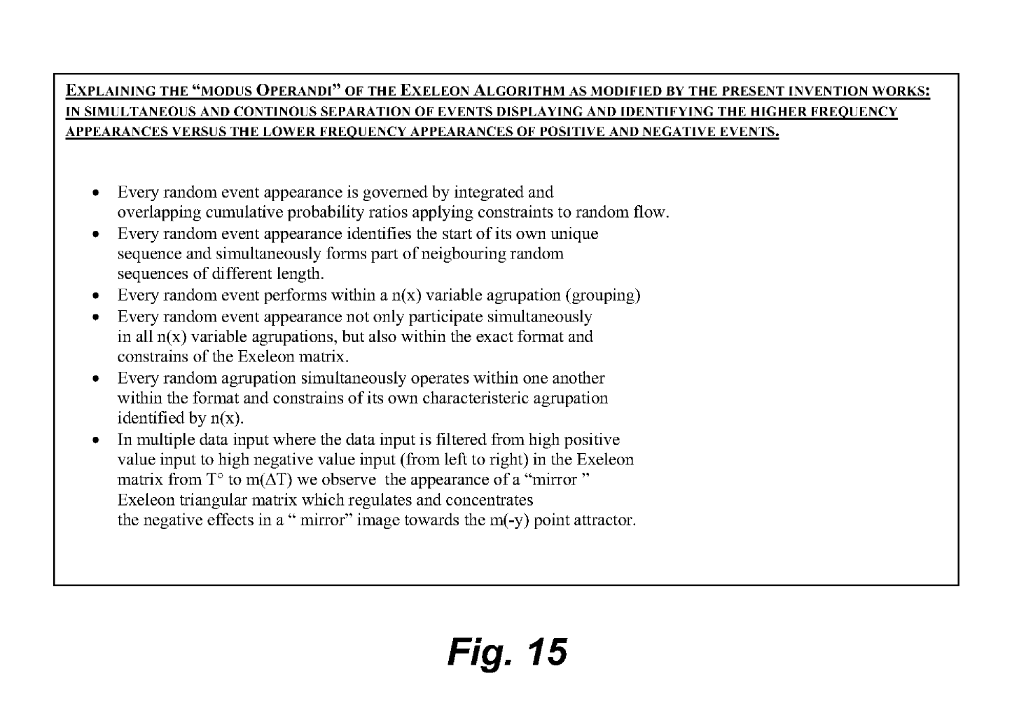

### DETAILED DESCRIPTION OF THE INVENTION

The invention is directed to a method for detecting and/or predicting positive and negative performance trends in stock markets in real time or based on historical data and to use detected trends as an aid to make stock deals.

The present invention makes use of the Exeleon algorithm as described in U.S. Patent Application Number 20060293912 (published Dec. 28, 2006). U.S. Patent Application Number 20060293912 is herein incorporated by reference in its entirety.

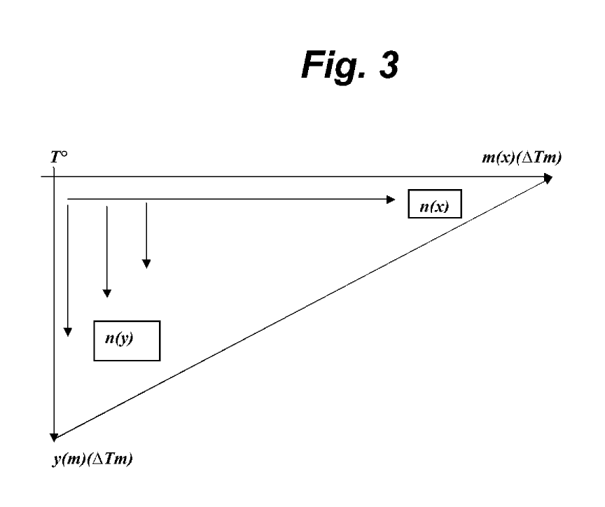

The patent pending Exeleon Algorithm matrix functions on a series of single data point entries into the Exeleon matrix according to Exeleon algorithm which includes an allocation procedure (see, e.g., paragraph labelled “[0013]” and FIG. 3 in U.S. Patent Application Number 20060293912).

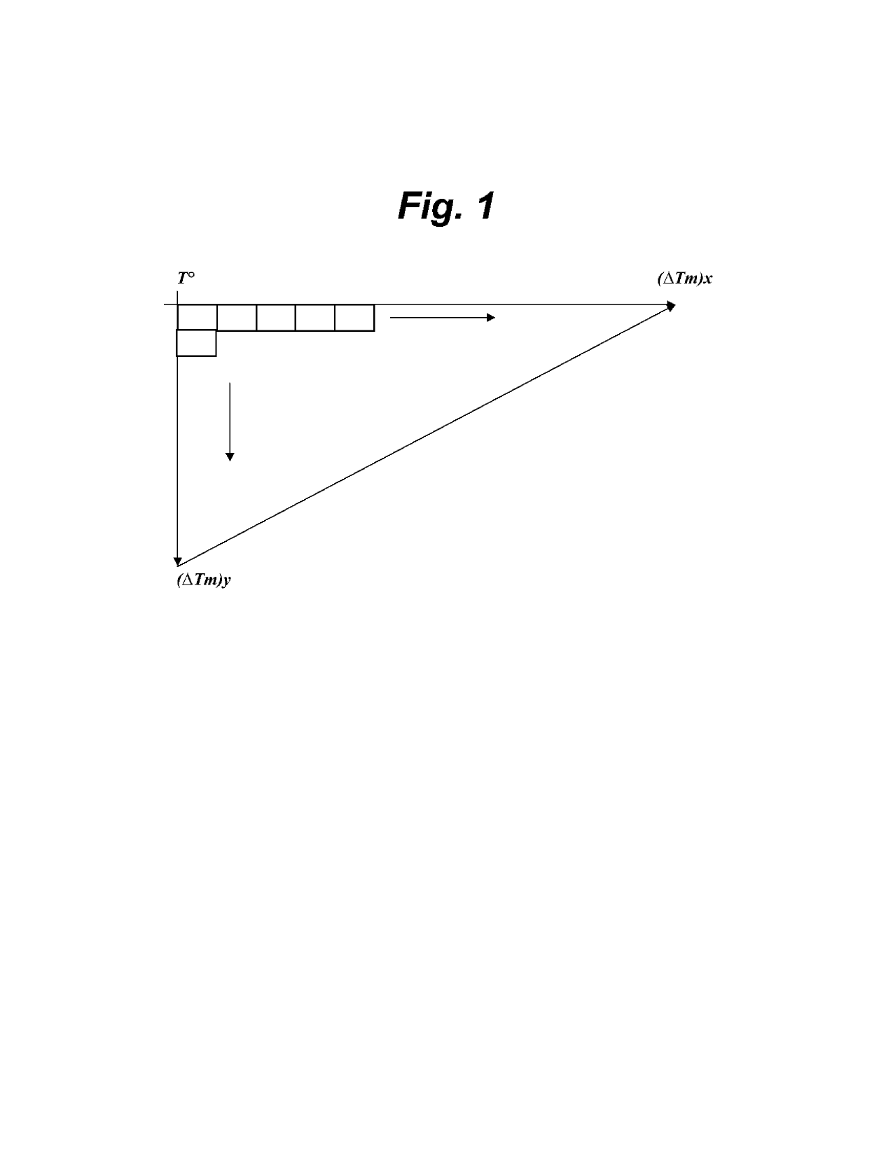

Analysing stock market data we encounter multiple data entries at the same time. In a single entry analysis (see, e.g., roulette example in U.S. Patent Application Number 20060293912) we encounter a specific random event appearance per time interval, followed by another random event etc., until we arrive at the triangular shape Exeleon matrix (see FIG. 1). In direct contrast, with a stock market we encounter every share price and or share performance (positive or negative movement in relation to the previous data sourcing per set time interval) arriving at the exact same time as a multiple data input source. The Exeleon matrix can be multidimensional, having both x and y rows and hence 2-dimensional and then combined with a third dimension z to allow the Exeleon methodology of the present invention to process a plurality of stocks simultaneously. For example, a plurality of 2-D matrices corresponding to each of a plurality of stock in accordance with the Exeleon algorithm of the present invention.

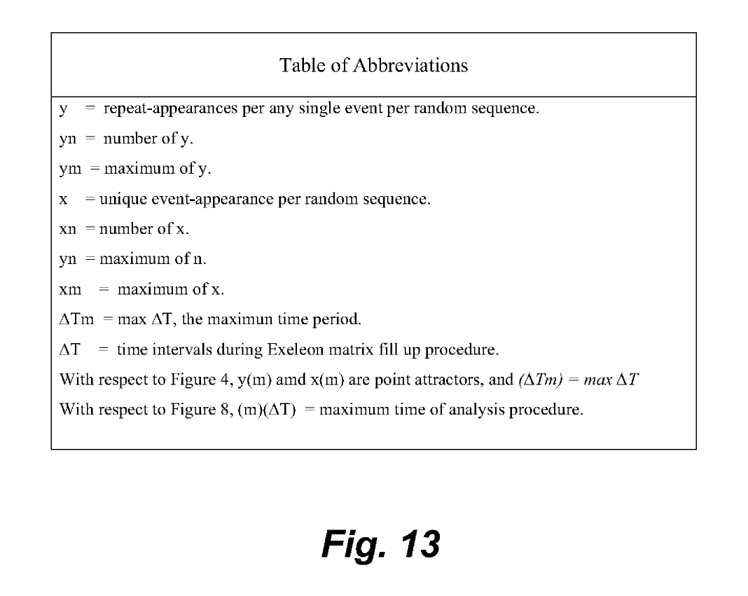

The inventor has found a way of handling multiple-data-input as described below. To aid the reader a list of abbreviations is shown in FIG. 13.

### Exeleon Multiple-Data-Input Algorithm.

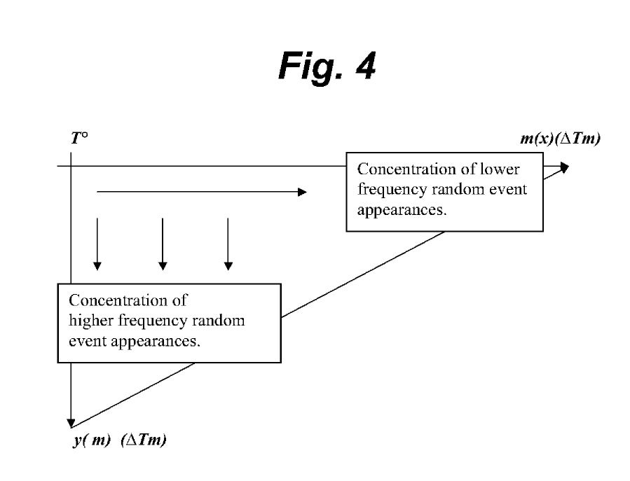

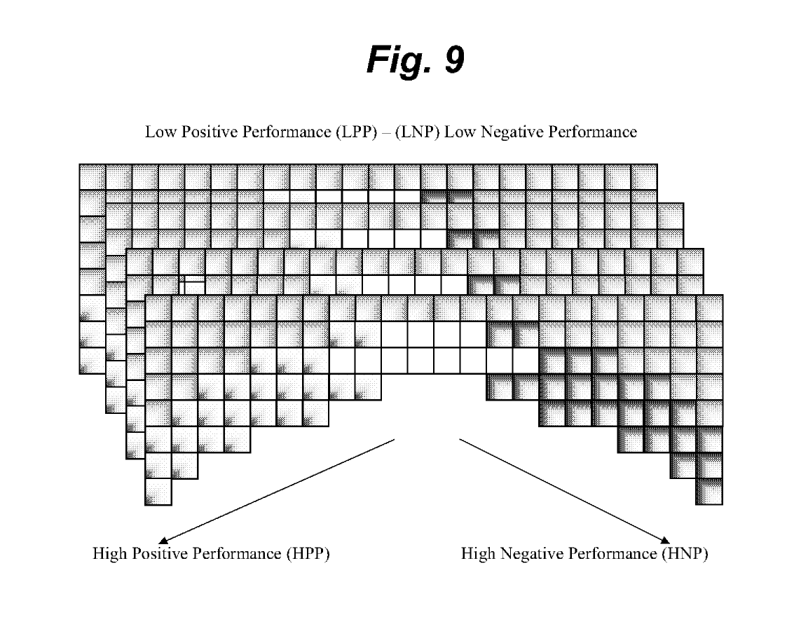

a) Determine total amount of events, (shares), x(m) to be studied.
b) Code x(m), with lossy block coding procedure; a total amount of x(m)/z blocks or fields (in U.S. Patent Publication No. 20060293912 and FIG. 4 therein, FIG. 4 shows a matrix comprising 22 blocks made up of a first row or level (labelled L1) of nine numeric fields, a second row (labelled L2) of 6 numeric fields, a third row (labelled L3) of 4 fields, a fourth row (labelled L4) of two fields, and a fifth row (labelled L5) consisting of just one field (B1, L5 or L5,B1),
c) Identify each xz for example xz1=a; xz2=b; xz3=c
d-f) Introduce identifiers; a, b, c etc. into the Exeleon matrix at time point T° and allow free flow of random events (shares performances; % (a.np/a.pp.T¹)*¹ as per frequency appearance(ΔT), according to the Exeleon fill-up-methodology to distribute the randomness of % (a.np/app.T¹), followed by % (b.np/bpp.T¹)*² from high to low plotted from left to right towards the outer points of the Exeleon matrix namely T¹. (See FIG. 9),
g) Repeat (d-f) above at time T² and at more time intervals (ΔT) until order appears in the random flow with automatic separation of high performing shares in Exeleon matrix area A, versus low performing shares in Exeleon matrix area B.

The trend (as a spectrum distributed
from line T=1 to line (m)(ΔT) becomes self evident.
*¹% (a.np/a.pp.T¹) new price of block a as a percentage of previous price block a, at time interval T¹%
*²% (b.np/b.pp.T¹) new price of block b as a percentage of previous price block b, at time interval T¹
As we in share-performance desire to monitor the % share performance of the entire spectrum of possible outcomes per different time intervals, as opposed to only monitoring the appearance of the highest or lowest individual shares occurrence, introduction of share performance input are not with single event entries but with multiple event entries (the entire spectrum of the market) per ΔT. By introducing multiple data input as opposed to single data input the Exeleon matrix changes its format from a triangle matrix to a box matrix format.

Above EXELEON MULTI DATA INPUT ALGORITHM methodology will allow spectra analysis per time interval instead of only point analysis per time interval, which is desired when the entire spectrum of a stock market is introduced and analysed during the same time frame. This will additionally allow accurate calculations to be made regarding the movement of any stock market index and or certain sections of the index. For example a stock market index can suddenly, because of certain information, move towards negativity, but with closer analysis it may be that only a certain sector of the index (for example, the banking sector found to be the dominant negative factor). The banking sector's negative effect can be so large, that it pulls the entire index lower, which can give a false negative reading for buying non-banking industry shares.

### Exeleon Multiple Data Entry Input Algorithm.

a) Determine total amount of shares, x(m) to be studied.
b) Code x(m), with lossy block coding with a total amount of x(m)/z blocks.
c) Identify each xz for example xz1=a; xz2=b; xz3=c
d-f) Introduce a, b, c . . . into Exeleon matrix at time point T° and allow free flow of random shares performance; % (a.np/a.pp.T¹)*¹ as per frequency appearance(ΔT), according to the Exeleon fill-up-methodology to distribute the randomness of % (a.np/app.T¹), followed by % (b.np/bpp.T¹)*² from high to low plotted from left to right towards the outer points of the Exeleon matrix namely T¹
g) Repeat (d-f) above at time T² and at more time intervals (ΔT) until order appears in the random flow with automatic separation of high performing shares in Exeleon matrix area A, versus low performing shares in Exeleon matrix area B.

The trend (as a spectrum distributed

from line T=1 to line (m)(ΔT) becomes self evident.
*¹% (a.np/a.pp.T¹) new price of block a as a percentage of previous price block a, at time interval T¹
*²% (b.np/b.pp.T¹) new price of block b as a percentage of previous price block b, at time interval T¹

As we in share-performance desire to monitor the % share performance of the entire spectrum of possible outcomes per different time intervals, as opposed to only monitoring the appearance of the highest or lowest individual share, introduction of share-performance-applications are not with single event entries but rather with the entire spectrum of the market per ΔT.

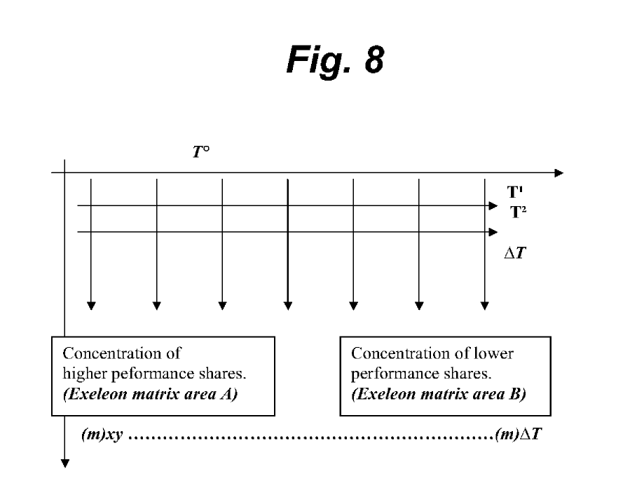

The Exeleon matrix hereby changes its format from a triangle matrix to a box matrix, by operating as two opposing Exeleon triangle matrices in a mirror image, separating simultaneously positive and negative performances by means of all integrated and overlapping possible agrupations, which satisfies the requirement of n(x)>1 (see FIGS. 8-10).

### Working Example 1

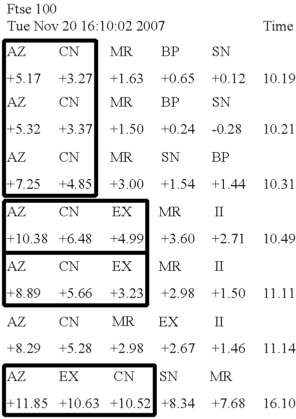

It is clear that the top 3 groups, AZ, EX and CN were already identified
as the top 3 groups by 10.49 AM on Tuesday, November 20, 2006.
These 3 groups ended the day with 11.85%; 10.63% and 10.52% increase
in performance from opening.
Identification at 11.21 of group AZ at 5.32%; and group CN at 3.37%,
gave group AZ a net profit of (11.85% - 5.32%) = 6.53% and group CN a
net profit of (10.52% - 3.37%) = 7.15 %.
Group EX was identified at 10.11 at 3.23% and ended the day with 10.63%,
for a net profit of 7.14%.

### Working Example 2

### FTSE Mar. 27, 2008

### High Positive Performance Analyses

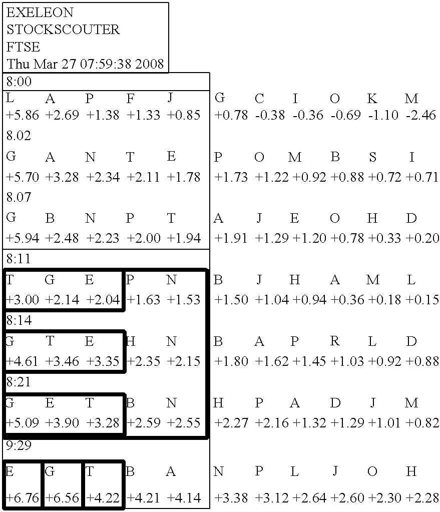

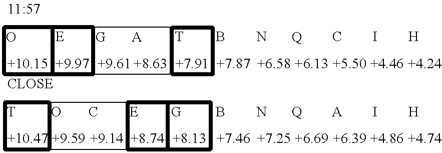

T,G and E were already identified as the top 3 groups by 8.11 am.
on Thursday 27^{th} of March 2007.
Identification at 8:11 of group T at 3.00%; ending at close of market at
10.47% with a profit of 7.47%. Group G with a profit of (8.13% - 2.14%) =
5.99% and Group E with a profit of (8.74% - 3.35%) = 5.39%

### Working Example 3

### FTSE Apr. 1, 2008

### High Negative Performance Analyses

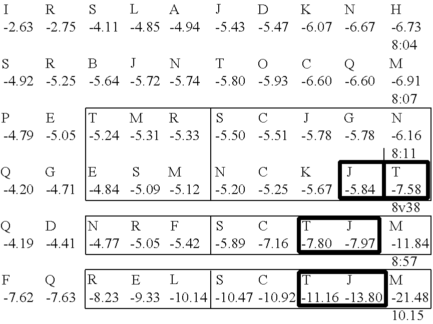

T, and J were already identified as the bottom 2 groups by 8:11 am. on
Monday 1st of April 2008.
Group T (selling short) showed a profit of (11.16% -7.58%) = 3.58%
Group J (selling short) showed a profit of (13.80% - 5.84% ) = 7.96%.
By adding positive parts of the matrix and comparing it with negative parts of
the Exeleon Matrix the
movement of the entire index can be displayed at an early stage, which allows
timely predictions for profiteering.

Similar results were obtained in accessing the Nasdaq and Tokyo stock markets.

With this extension of the Exeleon patent pending algorithm to also operate with Multiple Data Input as a parameter we found that the Exeleon algorithm functions remarkably well to display stock market performance (negative and positive), which allows accurate predictions in real time. The Exeleon algorithm for Multiple Data Input also revealed a “mirror” image of positive performance which operates in conjunction with negative performance outcomes.

The Exeleon algorithm for Multiple Data Input also strengthens the concept that stock market movements indeed operates on a random walk principle. The reason behind this is that the Exeleon algorithm is the only known algorithm which can display random data flow and its success with stock market analysis strengthens therefore the random walk principle governing share movements.

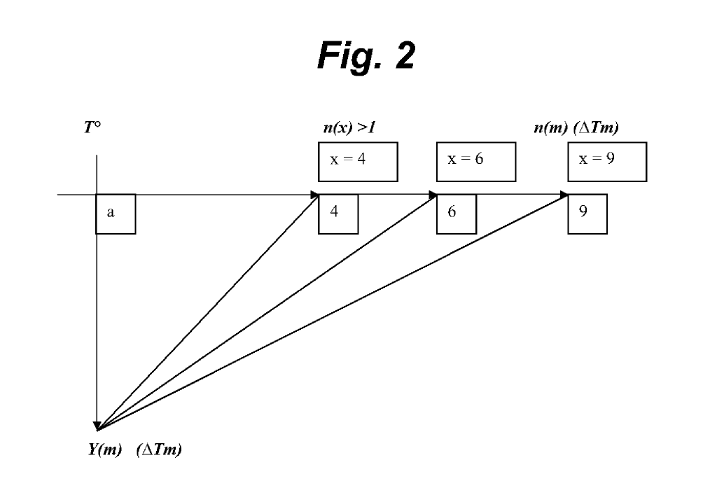

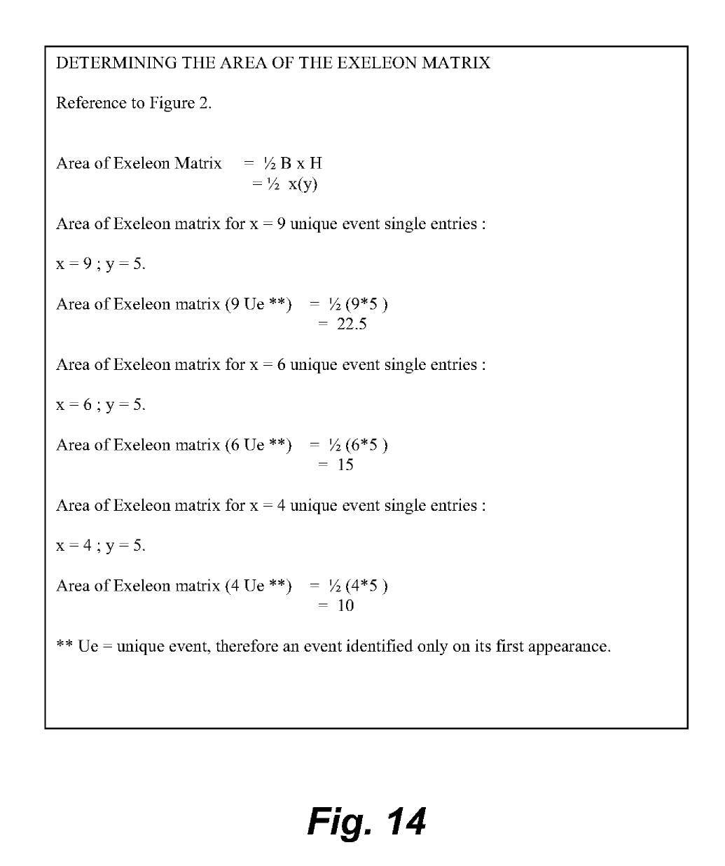

With regard to FIG. 2, the exemplar matrix is filled in using the modified Exeleon algorithm of the present invention in real time. Exeleon matrix area determined by n(x)>1. For example, the Exeleon algorithm x4; identifying x(a4) as a maximum 4 variable Exeleon matrix, operates simultaneously within Exeleon algorithm x6; identifying x(a6) as a maximum 6 variable Exeleon matrix, operates simultaneously within Exeleon algorithm x9; identifying x(a9) as a maximum 9 variable Exeleon matrix, operates simultaneously within higher maximum variable Exeleon matrices. FIG. 14 shows a non-limiting example of how to calculate the area of the matrix shown in FIG. 2.

With regard to FIG. 3, the Exeleon matrix shown is representative of a set area per random data cycle, which can be determined by ½ m(x).m(y). The inventor has found that the Exeleon matrix fills up with an accuracy of about 90% per random cycle per Exeleon allocation procedure.

With regard to FIG. 4, the larger the value of n(x), the better separation is achieved between high frequency and low frequency appearances of random data x(n) is therefore a factor to determine the separation efficiency of high frequency and low frequency appearances of random numbers and or groups.

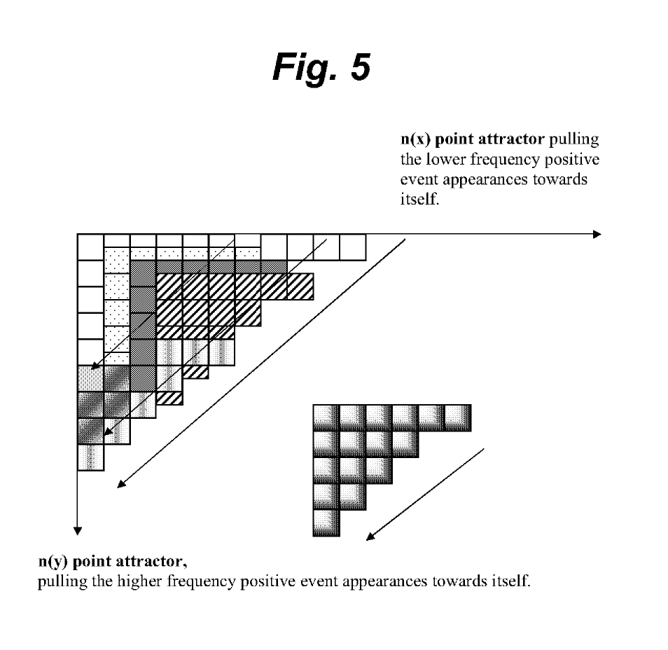

With regard to FIG. 5, high frequency positive events are pulled from a higher and right side of the Exeleon matrix triangle and concentrated in the lower left corner of the Exeleon matrix triangle by the (x) y point attractor. This Exeleon high frequency random event appearance concentration effect operates simultaneously on all possible Exeleon matrix fitted triangles, integrating and overlapping as shown.

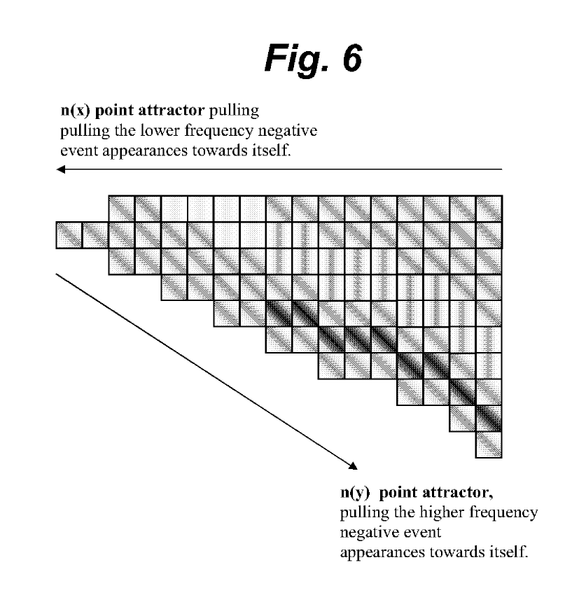

With regard to FIG. 6, high frequency negative random events are pulled from a higher and left side of the Exeleon matrix triangle and concentrated in the lower right corner of the Exeleon matrix triangle by the (x)y point attractor. This Exeleon high frequency random event appearance concentration effect operates simultaneously on all possible Exeleon matrix fitted triangles integrating and overlapping.

With regard to FIG. 9, it is interesting that a Low Positive Performance is equal to a Low Negative Performance in the Exeleon Matrix for Multiple Data Input. We will therefore for the sake of simplicity identify only three main points in the Exeleon Matrix for Multiple Data Input.

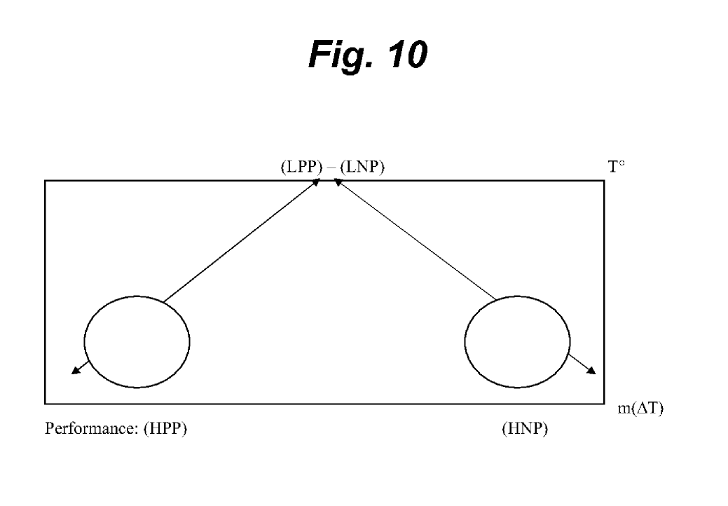

With regard to FIG. 10, in determining the Highest Share Performers and Lowest Share Performers per time interval of interest, of interest are the depicted circle areas of HPP (High Positive Performers) and HNP (High Negative Performers).

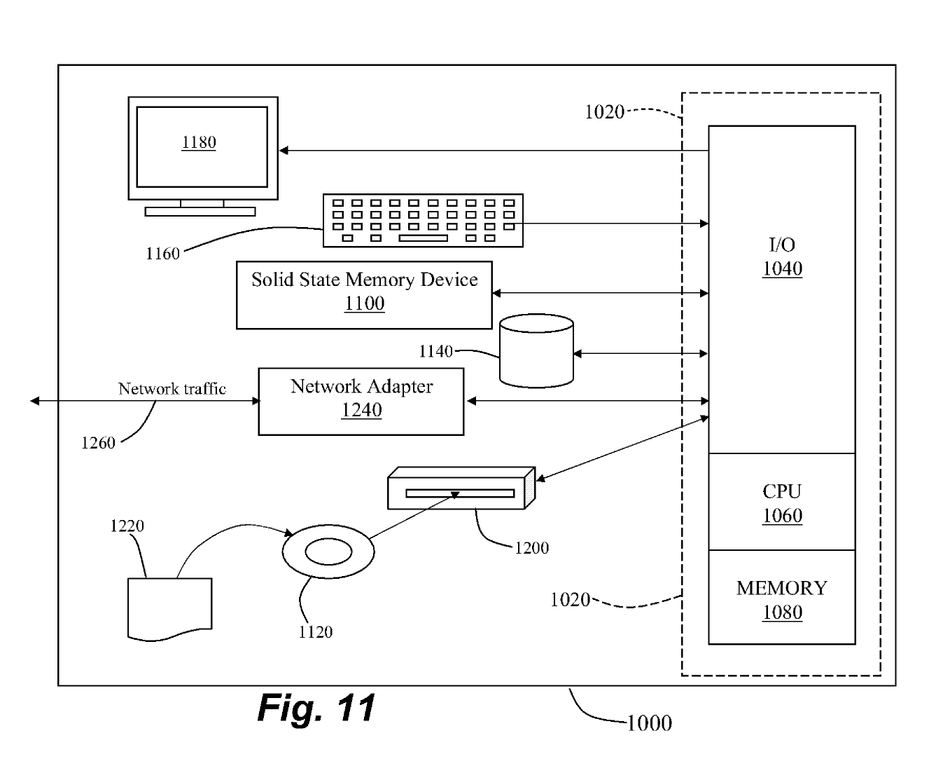

FIG. 11 depicts an example of a computing system 1000 capable of executing the embodiments of the present invention. In such a system, data and program files may be input to the computing system 1000, which reads the files and executes the programs therein. A control module, illustrated as a processor 1020, is shown having an input/output (I/O) section 1040, at least one microprocessor, or at least one Central Processing Unit (CPU) represented in FIG. 10 by a CPU 1060, and a memory section 1080. The present invention is optionally implemented in software or firmware modules loaded in memory 1080 and/or stored on a solid state, non-volatile memory device 1100, a configured ROM disk such as a configured CD/DVD ROM 1120 or a disk storage unit 1140. The computing system 1000 can be used as a “special-purpose” machine for implementing the present invention.

The I/O section 1040 is connected to a user input module 1160, e.g., a keyboard; an output unit, e.g., a display unit 1180 for displaying Exeleon matrices of the present invention, and one or more program storage devices, such as, without limitation, the solid state, non-volatile memory device 1100, the disk storage unit 1140, and a disk drive unit 1200. The user input module 1160 is shown as a keyboard, but may also be any other type of apparatus for inputting commands into the processor 1020. The solid state, non-volatile memory device 1100 can be an embedded memory device for storing instructions and commands in a form readable by the CPU 1060.

The solid state, non-volatile memory device 1100 may be Read-Only Memory (ROM), an Erasable Programmable ROM (EPROM), Electrically-Erasable Programmable ROM (EEPROM), a Flash Memory or a Programmable ROM, or any other form of solid state, non-volatile memory. The disk drive unit 1200 is a CD/DVD-ROM driver unit capable of reading the CD/DVD-ROM medium 1120, which typically contains programs 1220 and data. The program components of the present invention contain the logic steps to effectuate the systems and methods in accordance with the present invention and may reside in the memory section 1080, the solid state, non-volatile memory device 1100, the disk storage unit 1140 or the CD/DVD-ROM medium 1120.

In accordance with an alternative embodiment, the disk drive unit 1200 may be replaced or supplemented by a floppy drive unit, a tape drive unit, or other storage medium drive unit.

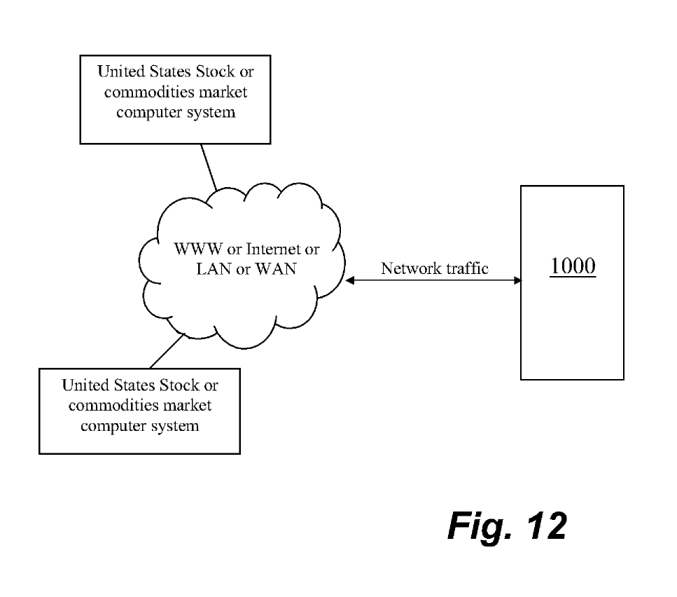

A network adapter 1240 is capable of connecting the computing system 1000 to one or more stock market computer systems based in the United States or abroad (see FIG. 12) or a remote computer in communication with a stock market during trading hours via a network link 1260 and thence via, for example, the Internet or a dedicated communication line. Communication between the computing system 1000 and a stock market of interest can be achieved using hypertext transfer protocol (HTTPS) over a secure socket layer. The network adapter 1240 can be configured to receive and send messages wirelessly or to send/receive messages via a hard line such as a fibre optic cable (e.g., in operation with a cable company such as, but not limited to, COMCAST, COX, or a private network).

Software instructions to perform the present invention can be stored on the solid state, non-volatile memory device 1100, the disk storage unit 1220, or the CD/DVD-ROM 1120 are executed by the at least one CPU represented in FIG. 10 by CPU 1060. Data, such as stock prices may be stored in memory section 1080, or on the solid state, non-volatile memory device 1100, the CD/DVD-ROM 1120, the disk storage unit 1220, the disk drive unit 1200 or other storage medium units operatively coupled to the system 1000.

In accordance with one embodiment, the computing system 1000 further comprises an operating system and usually one or more application programs. The operating system comprises a set of programs that control operations of the computing system 1000 and allocation of resources. The set of programs, inclusive of certain utility programs, may also provide a graphical user interface to the user. An application program is software that runs on top of the operating system software and uses computer resources made available through the operating system to perform application specific tasks desired by the user. In accordance with an embodiment, the operating system employs a graphical user interface wherein the display output of an application program is presented in a rectangular area on the screen of the display device 1180. The operating system can be any suitable operating system, and may be any of the following: Microsoft Corporation's “WINDOWS 95,” “WINDOWS CE,” “WINDOWS 98,” “WINDOWS 2000”, “WINDOWS NT”, XP or VISTA operating systems, IBM's OS/2 WARP, Apple's MACINTOSH SYSTEM 8 operating system, ULTRIX, VAX/VMS, UNIX or LINUX with the X-windows graphical environment, and any suitable operating system under development such as Microsoft's anticipated replacement of the VISTA operating system.

I claim:

1. A computer readable medium containing program instructions for detecting and displaying trends in an active stock market to facilitate a stock dealer to make buy or sell decisions, wherein execution of the program instructions by one or more processors of a computer system causes the one or more processors to simultaneously monitor in real time a plurality of stocks to detect trends therein by carry out the steps of:
(a) determining a set of possible outcomes associated with a plurality of stocks in an active stock market;
(b) coding the possible outcomes to provide a plurality of separate groups, wherein each possible outcome is systematically allocated to one of the groups;
(c) allocating an identifier to each of the groups;
(d) providing at least one matrix comprised of a plurality of cells arranged in rows;
(e) monitoring in real time changes to the stock prices of the stocks and assigning changes to the stock prices to a group in accordance with step (b);
(f) using an Exeleon allocation procedure to allocate each identifier generated in step (e) to said at least one matrix; and
(g) repeating step (f) until a trend of duplicating identifiers is identified and displaying the results thereby establishing a rational basis for buying or selling the stock;
wherein upon completion of step (g) an operator can decide whether to make a stock transaction.
